(19) United States
(12) Patent Application Publication
(10) Pub. No.: US 2019/0378043 A1
(43) Pub. Date: Dec. 12, 2019

(54) TECHNOLOGIES FOR DISCOVERING SPECIFIC DATA IN LARGE DATA PLATFORMS AND SYSTEMS

(71) Applicant: ZYLO, INC., Indianapolis, IN (US)

(72) Inventors: Benjamin Pippenger, Indianapolis, IN (US); Mark Clerkin, Indianapolis, IN (US); Ryan Carroll, Indianapolis, IN (US); Owen Mockler, Indianapolis, IN (US); Charlene Tay, Indianapolis, IN (US)

(73) Assignee: ZYLO, INC., Indianapolis, IN (US)

(21) Appl. No.: 16/439,313

(22) Filed: Jun. 12, 2019

Related U.S. Application Data
(60) Provisional application No. 62/683,924, filed on Jun. 12, 2018.

(51) Int. Cl. G06N 20/00; G06F 16/22; G06F 16/23; G06Q 10/06

(52) U.S. Cl. CPC G06N 20/00; G06Q 10/06313; G06F 16/2379; G06F 16/22

(57) ABSTRACT

Systems, devices, and/or methods may implement one or more machine learning models for finding specific data/items from one or more enterprise resource platforms. The one or more machine learning models may be running on any new (e.g., fresh) transactions that may be fed to/from the one or more enterprise payment systems. The one or more machine learning models may be configured to determine an association between software (e.g., application, program, code, etc.) subscription, purchase, and/or a license and at least one transaction. The one or more models may learn the association and/or may adjust one or more future matches, for example based on the learned associations. Perhaps as the one or more models run, at least one confidence score may be associated with one or more, or each, match made. The confidence score may indicate the confidence and/or reliability of the one or more associations to an end user.

### CROSS-REFERENCE TO RELATED APPLICATIONS

This application claims the benefit of U.S. Provisional Patent Application No. 62/683,924, filed on Jun. 12, 2018, the contents of which being incorporated by reference herein in its entirety, for all purposes.

### BACKGROUND

With the move of enterprise software to cloud-based/non-cloud-based models, many employees may become a software buyer. Consequently, companies have lost the visibility into the software that is being purchased. This lack of visibility may limit the application of subscription based services across a broader part of an organization.

Existing software audit systems are not reliable since they are unable to determine when a (e.g., new and/or renewal) software purchase, license, and/or subscription service is added to the enterprise. Since new Software as a Service (SaaS) and/or cloud-based /non-cloud-based software-use agreements may be created and/or purchased every day, and throughout any day, any audit(s) of software purchase(s), license(s), and/or subscription service(s) may be quickly (e.g., immediately) out-of-date, perhaps as soon as, or shortly after, such an audits is completed.

### SUMMARY

Systems, methods, and/or devices, may be configured to implement one or more computer program products/techniques that may utilize one or more machine learning algorithms and/or one or more outbound financial transactions that may occur/operate across an enterprise. One or more techniques may identify when one or more software (e.g., applications, purchases, licenses, and/or subscriptions fees are being paid to a cloud-hosted/non-cloud-hosted software vendor and/or service provider. One or more techniques may identify what software title for which at least one software (e.g., application, program, code, etc.) purchase, license, and/or subscription fee was transacted.

One or more techniques may determine specific data from an enterprise resource platform. One or more techniques may include receiving one or more input data from an enterprise management platform. One or more techniques may include preparing the input data for analysis by a machine-learning model. One or more techniques may include performing the analysis of the prepared data using, at least, the machine-learning model. One or more techniques may include determining at least one instance of the specific data from the prepared data based, at least, on the analysis. One or more techniques may include storing the at least one instance of the specific data in a database. One or more techniques may include determining at least one transaction conducted on the enterprise resource platform based on the at least one instance of the specific data. One or more techniques may include storing the at least one transaction in the database.

One or more techniques may include classifying the at least one transaction as a verified transaction. One or more techniques may include training the machine-learning model using at least one of: the at least one instance of the specific data, or the verified transaction, to improve an effectiveness of the machine-learning model in the performance of the analysis of the prepared data. One or more techniques may include storing the trained machine-learning model in the database.

One or more techniques may include performing the analysis of the prepared data using the trained machine-learning model on the prepared data. One or more techniques may include determining the at least one instance of the specific data by matching the at least one instance of the specific data with one or more matching templates created during a verification of previous analysis from the machine-learning model.

One or more techniques may include performing analysis of the prepared data using by applying a plurality of machine-learning models to the prepared data. One or more technique may include performing the analysis of the prepared data by generating a first analysis result from a first block of machine-learning models of the plurality of machine-learning models. One or more techniques may include determining an accuracy of the first result. The accuracy may be a positive determination, a negative determination, and/or an indeterminate determination.

One or more techniques may include forwarding the first analysis to a second block of machine-learning models of the plurality of machine-learning models for further processing when the accuracy of the first result is the positive determination. One or more techniques may include identifying the prepared data corresponding to the first analysis result. One or more techniques may include discarding the prepared data corresponding to the first analysis result when the accuracy of the first result is the negative determination. One or more techniques may include forwarding the first analysis back to the first block of machine-learning models of the plurality of the machine-learning models for further processing when the accuracy of the first result is the indeterminate determination.

In one or more techniques, the at least one transaction may be at least one of: a software (e.g., application, program, code, etc.) subscription transaction, a software (e.g., application, program, code, etc.) purchase transaction, or a software (e.g., application, program, code, etc.) license transaction. In one or more techniques, the at least one transaction conducted on the enterprise resource platform may be determined based on the at least one instance of the specific data comprises. One or more techniques may include associating the at least one instance of the specific data with the software (e.g., application, program, code, etc.) subscription transaction, the software (e.g., application, program, code, etc.) purchase transaction, and/or the software (e.g., application, program, code, etc.) license transaction.

One or more techniques may include determining a measure of a reliability of the association of the at least one instance of the specific data with the software (e.g., application, program, code, etc.) subscription transaction, the software (e.g., application, program, code, etc.) purchase transaction, and/or the software (e.g., application, program, code, etc.) license transaction based on input from a verification process.

One or more techniques may include receiving the input data from the enterprise management platform by receiving the input data via an application programming interface (API) periodic processing and/or by receiving the input via a batch processing.

One or more techniques may include preparing the input data for the analysis by the machine-learning model by cleansing the input data and/or by transforming the input data. In one or more techniques, the cleansing the input data may include removing one or more stopwords from the input data and/or reducing one or more ambiguous words from the input data.

### BRIEF DESCRIPTION OF THE DRAWINGS

The features, elements, devices, systems, methods, advantages, and disclosures contained herein, and the manner of attaining them, will become apparent and the present disclosure will be better understood by reference to the following description of various examples of the present disclosure taken in conjunction with the accompanying drawings, wherein:

FIG. 1 is a diagram of an example computer/computing device that may implement one or more techniques described herein;

FIG. 2 is an example technique flow chart according to the present disclosure;

FIG. 3 illustrates an example technique analysis output according to the present disclosure;

FIG. 4 is an example technique flow chart according to the present disclosure;

FIG. 5 illustrates an example a Recurrent Neural Network (RNN) cell back-propagation;

FIG. 6 illustrates an example of a Recurrent Neural Network (RNN) cell;

FIG. 7 illustrates an example of a Recurrent Neural Network (RNN) sequence; and

FIG. 8 illustrates an example of Long Short-Term Memory (LSTM) network cell.

### DETAILED DESCRIPTION

For the purposes of promoting an understanding of the principles of the present disclosure, reference will now be made to one or more examples illustrated in the drawings, and specific language will be used to describe the same. No limitation of the scope of this disclosure is thereby intended.

One or more of the technologies described herein relates to enterprise audit systems, and more particularly to enterprise audit systems for software (e.g., application, program, code, etc.) purchases, licenses and/or subscriptions. Systems, methods, and/or devices, may be configured to implement one or more computer program products/techniques that may (e.g., dynamically) identify newly (e.g., recently) created software use transactions and/or learn to associate a financial transaction with a software (e.g., application, program, code, etc.) subscription, purchase, or lease of software (e.g., application, program, code, etc.).

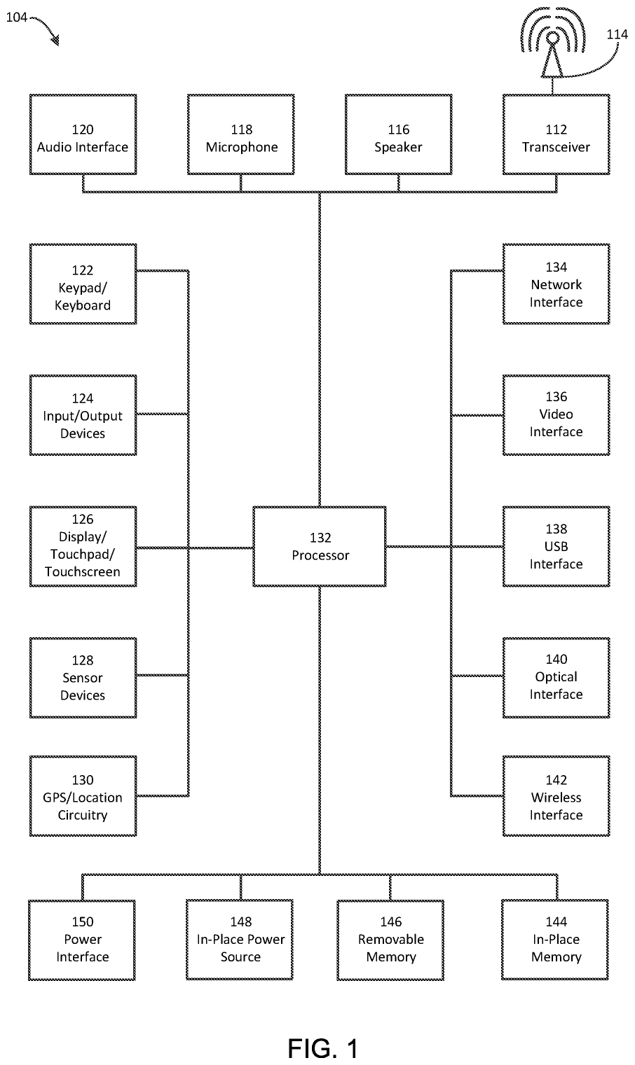

FIG. 1 is a diagram of an example computer/computing (e.g., processing) device 104 that may implement one or more techniques described herein, in whole or at least in part, with respect to one or more of the devices, methods, and/or systems described herein. In FIG. 1, the computing device 104 may include one or more of: a processor 132, a transceiver 112, a transmit/receive element (e.g., antenna) 114, a speaker 116, a microphone 118, an audio interface (e.g., earphone interface and/or audio cable receptacle) 120, a keypad/keyboard 122, one or more input/output devices 124, a display/touchpad/touch screen 126, one or more sensor devices 128, Global Positioning System (GPS)/location circuitry 130, a network interface 134, a video interface 136, a Universal Serial Bus (USB) Interface 138, an optical interface 140, a wireless interface 142, in-place (e.g., non-removable) memory 144, removable memory 146, an in-place (e.g., removable or non-removable) power source 148, and/or a power interface 150 (e.g., power/data cable receptacle). The computing device 104 may include one or more, or any sub-combination, of the aforementioned elements.

The computing device 104 may take the form of a laptop computer, a desktop computer, a computer mainframe, a server, a terminal, a tablet, a smartphone, and/or a cloud-based computing device (e.g., at least partially), and/or the like.

The processor 132 may be a general-purpose processor, a special-purpose processor, a conventional processor, a digital-signal processor (DSP), a plurality of microprocessors, one or more microprocessors in association with a DSP core, a controller, a microcontroller, one or more Application Specific Integrated Circuits (ASICs), one or more Field Programmable Gate Array (FPGAs) circuits, any other type of integrated circuit (IC), and/or a finite-state machine, and/or the like. The processor 132 may perform signal coding, data processing, power control, sensor control, interface control, video control, audio control, input/output processing, and/or any other functionality that enables the computing device 104 to serve as and/or perform as (e.g., at least partially) one or more of the devices, methods, and/or systems disclosed herein.

The processor 132 may be connected to the transceiver 112, which may be connected to the transmit/receive element 124. The processor 132 and the transceiver 112 may operate as connected separate components (as shown). The processer 132 and the transceiver 112 may be integrated together in an electronic package or chip (not shown).

The transmit/receive element 114 may be configured to transmit signals to, and/or receive signals from, one or more wireless transmit/receive sources (not shown). For example, the transmit/receive element 114 may be an antenna configured to transmit and/or receive RF signals. The transmit/receive element 114 may be an emitter/detector configured to transmit and/or receive IR, UV, or visible light signals, for example. The transmit/receive element 114 may be configured to transmit and/or receive RF and/or light signals. The transmit/receive element 114 may be configured to transmit and/or receive any combination of wireless signals.

Although the transmit/receive element 114 is shown as a single element, the computing device 104 may include any number of transmit/receive elements 114 (e.g., the same as for any of the elements 112-150). The computing device 104 may employ Multiple-Input and Multiple-Output (MIMO) technology. For example, the computing device 104 may include two or more transmit/receive elements 114 for transmitting and/or receiving wireless signals.

The transceiver 112 may be configured to modulate the signals that are to be transmitted by the transmit/receive element 114 and/or to demodulate the signals that are received by the transmit/receive element 114. The transceiver 112 may include multiple transceivers for enabling the computing device 104 to communicate via one or more, or multiple, radio access technologies, such as Universal Terrestrial Radio Access (UTRA), Evolved UTRA (E-UTRA), and/or IEEE 802.11, for example.

The processor 132 may be connected to, may receive user input data from, and/or may send (e.g., as output) user data to: the speaker 116, microphone 118, the keypad/keyboard 122, and/or the display/touchpad/touchscreen 126 (e.g., a liquid crystal display (LCD) display unit or organic light-emitting diode (OLED) display unit, among others). The processor 132 may retrieve information/data from and/or store information/data in, any type of suitable memory, such as the in-place memory 144 and/or the removable memory 146. The in-place memory 144 may include random-access memory (RAM), read-only memory (ROM), a register, cache memory, semiconductor memory devices, and/or a hard disk, and/or any other type of memory storage device.

The removable memory 146 may include a subscriber identity module (SIM) card, a portable hard drive, a memory stick, and/or a secure digital (SD) memory card, and/or the like. The processor 132 may retrieve information/data from, and/or store information/data in, memory that might not be physically located on the computing device 104, such as on a server, the cloud, and/or a home computer (not shown).

One or more of the elements 112-146 may receive power from the in-place power source 148. In-place power source 148 may be configured to distribute and/or control the power to one or more of the elements 112-146 of the computing device 104. The in-place power source 148 may be any suitable device for powering the computing device 104. For example, the in-place power source 148 may include one or more dry cell batteries (e.g., nickel-cadmium (NiCd), nickel-zinc (NiZn), nickel metal hydride (NiMH), lithium-ion (Li-ion), etc.), solar cells, and/or fuel cells, and/or the like.

Power interface 150 may include a receptacle and/or a power adapter (e.g., transformer, regulator, and/or rectifier) that may receive externally sourced power via one or more AC and/or DC power cables, and/or via wireless power transmission. Any power received via power interface 150 may energize one or more of the elements 112-146 of computing device 104, perhaps for example exclusively or in parallel with in-place power source 148. Any power received via power interface 150 may be used to charge in-place power source 148.

The processor 132 may be connected to the GPS/location circuitry 130, which may be configured to provide location information (e.g., longitude and/or latitude) regarding the current location of the computing device 104. The computing device 104 may acquire location information by way of any suitable location-determination technique.

The processor 132 may be connected to the one or more input/output devices 124, which may include one or more software and/or hardware modules that provide additional features, functionality and/or wired and/or wireless connectivity. For example, the one or more input/output devices 124 may include a digital camera (e.g., for photographs and/or video), a hands free headset, a digital music player, a media player, a frequency modulated (FM) radio unit, an Internet browser, and/or a video game player module, and/or the like.

The processor 132 may be connected to the one or more sensor devices 128, which may include one or more software and/or hardware modules that provide additional features, functionality and/or wired and/or wireless connectivity. For example, the one or more sensor devices 128 may include an accelerometer, an e-compass, and/or a vibration device, and/or the like.

The processor 132 may be connected to the network interface 134, which may include one or more software and/or hardware modules that provide additional features, functionality and/or wireless and/or wired connectivity. For example, the network interface 134 may include a Network Interface Controller (NIC) module, a Local Area Network (LAN) module, an Ethernet module, a Physical Network Interface (PNI) module, and/or an IEEE 802 module, and/or the like.

The processor 132 may be connected to the video interface 136, which may include one or more software and/or hardware modules that provide additional features, functionality and/or wired and/or wireless connectivity. For example, the video interface 136 may include a High-Definition Multimedia Interface (HDMI) module, a Digital Visual Interface (DVI) module, a Super Video Graphics Array (SVGA) module, and/or a Video Graphics Array (VGA) module, and/or the like.

The processor 132 may be connected to the USB interface 138, which may include one or more software and/or hardware modules that provide additional features, functionality and/or wired and/or wireless connectivity. For example, the USB interface 138 may include a universal serial bus (USB) port, and/or the like.

The processor 132 may be connected to the optical interface 140, which may include one or more software and/or hardware modules that provide additional features, functionality and/or wired and/or wireless connectivity. For example, the optical interface 140 may include a read/write Compact Disc module, a read/write Digital Versatile Disc (DVD) module, and/or a read/write Blu-ray™ disc module, and/or the like.

The processor 132 may be connected to the wireless interface 142, which may include one or more software and/or hardware modules that provide additional features, functionality and/or wireless connectivity. For example, the wireless interface 142 may include a Bluetooth® module, an Ultra-Wideband (UWB) module, a ZigBee module, and/or a Wi-Fi (IEEE 802.11) module, and/or the like.

As described herein, with the move of enterprise software to cloud-based/non-cloud-based models (e.g., enterprise models), many employees may become a software buyer. As a result, companies may have lost visibility into the software (e.g., application, program, code, etc.) that is being purchased, license, and/or subscribed to, and/or used across the organization by perhaps many employees. Previously, companies had to either deploy manual methods to search through all transactions and/or rely on an outdated fuzzy matching logic. Traditional audit systems lack the ability to learn new applications, become out of date as soon as a manual audit is completed, and/or can take days or weeks to complete. By contrast, the one or more techniques described herein may operate/execute quickly, may run in real time, and/or may learn one or more associations between purchase transactions and users, perhaps for example as new applications are uncovered and/or identified.

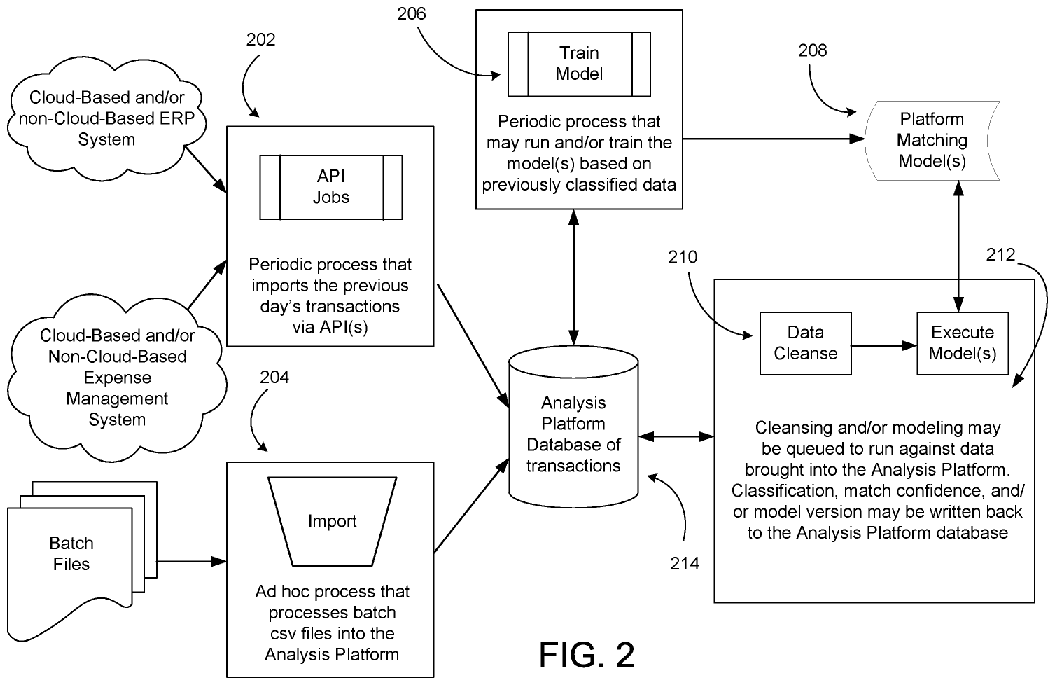

FIG. 2 is an example technique flow chart according to the present disclosure. Referring to FIG. 2, the systems, methods, and/or devices configured to implement one or more computer program products/techniques (e.g., ensemble model and/or one or more machine learning models) may be constantly and/or periodically (e.g., nightly) running to process any new transactions that they may be fed. As an association is made (e.g., as soon as an association is made) between a software (e.g., application, program, code, etc.) subscription, purchase, and/or license and a transaction, the one or more machine learning models may learn the association and/or may adjust future matches that may be made. In one or more scenarios, as the one or more models run, at least one confidence score may be generated for one or more, or each, association made. The at least one confidence score may indicate the confidence and/or reliability of the association of a software (e.g., application, program, code, etc.) subscription, license, and/or purchase transaction to an end user.

In one or more scenarios, this associated data, perhaps as a whole, may (e.g., begin to) paint a picture of spending and/or adoption trends (e.g., broadly) across multiple, or all, users and/or customers of a selected/targeted software product (e.g., application, program, code, etc.) purchase, subscription service, and/or license. The one or more models may identify one or more individual transactions. The one or more models and/or the platform may standardize and/or categorize this spending, perhaps for example such that insights and/or products can be created.

The one or more models may utilize/consider/perform one or more of: financial transaction data; transaction database(s) for receiving and/or storing the financial transaction data; data cleansing and/or transformation; machine learning: word vectors; machine learning: classical models and/or neural networks; an ensemble of one or more trained models; a process for the one or more models to receive and/or transform new (e.g., recent) financial transactions; model driven category and/or software application predictions; one or more processes for the system to upload predictions to the database; verification of the predictions and/or one or more models retrained based on feedback; and/or one or more processes to load and/or store the files created during training processes.

In one or more scenarios, financial data may flow from an integrated financial data source, such as an Enterprise Resource Planning platform (ERP) and/or an Expense Management platform, for example. In one or more scenarios, financial data may be manually uploaded into one or more transaction databases. At 206, there may be one or more processes that run to train the one or more models and/or apply the one or more models, perhaps for example to find matches and/or associations between a financial transaction and a software application.

In one or more scenarios, the one or more models may be trained on financial transaction data that may have been previously mapped to corresponding software applications and/or may have been verified (e.g., by the analysis platform and/or by a team of people). This data may, at 210, undergo a cleansing and/or transformation process that may prepare the imported financial transactions for the machine learning process. In one or more scenarios, the cleansing process may include removing stopwords and/or reducing ambiguous words that might not contribute to, and/or may interfere with, any of the one or more models' ability to predict transactions.

At 212, the cleaned data may flow through one or more machine learning pipelines, perhaps for example where the text data may be converted into at least two types of vector representations: TF-IDF vectorization and/or Word Embeddings. One or more vector representations for the financial transactions may be fed as input data into one or more (e.g., a suite of) classical and/or neural network based models, perhaps for example in order to analyze the incoming data and/or further train the one or more models to find matches. Perhaps for example when the aforementioned processes are complete, among other scenarios, the word embedding model, the trained suite/ensemble one or more models, the text corpus, and/or the encoded software providers may be stored (e.g., to be used to predict future incoming transactions).

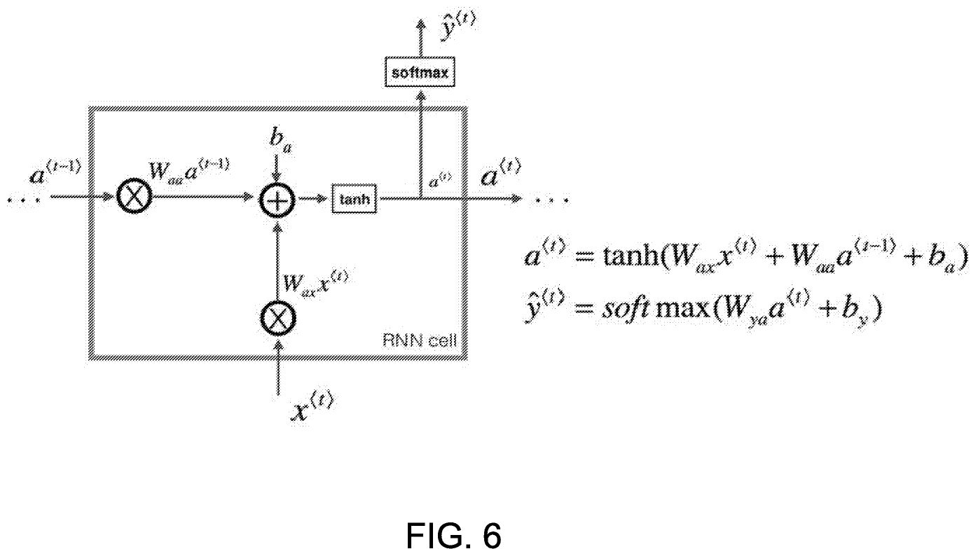

FIG. 6 illustrates an example Recurrent Neural Network (RNN) cell. In FIG. 6, the RNN cell may take as input x^{(t)} (current input) and a^{(t-1)} (e.g., that may be a previously hidden state containing information from past operations). The RNN cell may output a^{(t)} which may be given to a next RNN cell and/or may be used to predict ŷ^{(t)}. For example, in one or more scenarios, Wₐₓ is a weight matrix multiplying the input x^{(t}), Wₐₐ is a weight matrix multiplying the hidden state, W_{ya} is a weight matrix relating the hidden state to the output, b^{a} is a bias, b^{y} is a bias relating the hidden state to the output a^{(t)}.

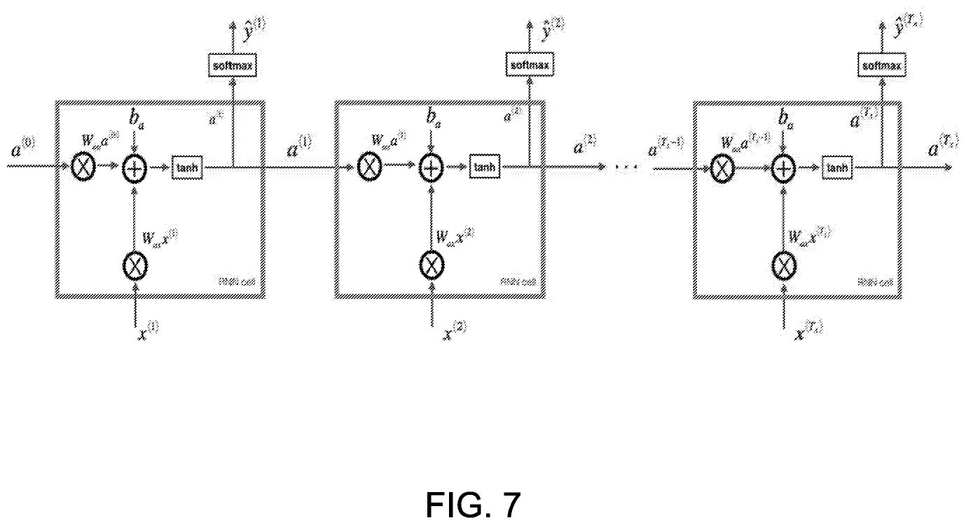

FIG. 7 illustrates an example RNN sequence, with one or more variables as described with respect to FIG. 6. In FIG. 7, an input sequence x=(x⁽¹⁾, x⁽²⁾, . . . , x^{(Tx)}) may be carried over Tₓ time steps. The network may output ŷ=(ŷ⁽¹⁾, ŷ⁽²⁾, ŷ^{(Tx)}).

Perhaps in order to make predictions in production, among other reasons, the encoded applications, trained embeddings, and/or vectorized text created during the training process may be loaded. The text from the incoming financial transaction files may be transformed in one or more processes, at least some of which may be substantially similar and/or identical to one or more used in the training process. The one or more trained models may be used to make one or more predictions. Referring again to FIG. 2, at 214, the one or more predictions may be stored in one or more databases. The processed data (e.g., stored predictions) may be reviewed and/or validated. Perhaps for example once reviewed, among other scenarios, the data may be made available for one or more further training routines. For example, a conditional probability of generating a target word from a given context may be found with:

$$( {w}_{c} \vert {w}_{{o}_{1}} , … , {w}_{{o}_{2 m}} ) = \frac{exp ( \frac{1}{2 m} {u}_{c}^{⊤} ( {v}_{{o}_{1}} + … + {v}_{{o}_{2 m}} ) )}{{\sum }_{i ∈ 𝓋} exp ( \frac{1}{2 m} {u}_{i}^{⊤} ( {v}_{{o}_{1 }} + … + {v}_{{o}_{2 m}} ) )} .$$

For example, in one or more scenarios, [symbol] is a conditional probability of generating a target word w_{c} given a set of context words wₒₗ, . . . , wₒ₂ₘ, that are indexed from 1 to 2m (m being the context size, an integer); vᵢ (vₒ₁, . . . vₒ₂ₘ) is the context word vector; uᵢ is the central target word vector of the word with index i in the vocabulary set V; u_{c} denotes a target word vector; u_{c}^{T} is the transpose of u_{c}; and uᵢ^{T} is the transpose of uᵢ.

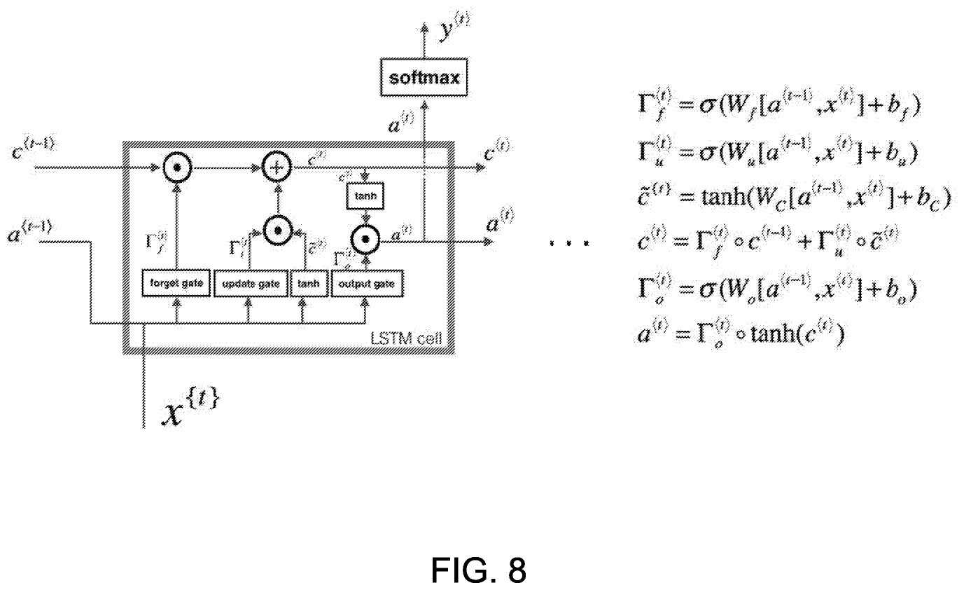

In one or more scenarios, the one or more ensemble/suite of models may use Long Short-Term Memory (LSTM) networks to make at least some of the one or more predictions. FIG. 8 illustrates an example of an LSTM cell that could be part of a LSTM network. For example, in one or more scenarios, t indexes the layers; f, u, and o index the forget gate, the update gate, and the output gate, respectively; x is the input; a is the output; F is a vector of values between 0 and 1; W_{f}, Wᵤ, Wₒ, and W_{c} are weight matrices for the forget, update, output, and tanh gates; \tilde{c}^{(t)} is the candidate value; c^{(t)} is the memory state of the cell; b_{f} is a bias for the forget gate; bᵤ is a bias for the update gate; b_{c} is a bias for the tanh gate; bₒ is a bias for the output gate; σ is the sigmoid function; and t denotes the time step.

In one or more scenarios, a Bayesian Hyperparameter Optimization may optimize the parameter space for the one or more tuning parameters for the logistic regression classifier for one or more binary classification models.

For example, in one or more scenarios, the following expressions and techniques may be used:

for t=1, 2, . . . do
find xₜ by optimizing the acquisition function over the Gaussian Process (GP):

xₜ=argmaxₓ u(x| [symbol] _{1:t-1}).
Sample the objective function: yₜ=f(xₜ)+εₜ.
Augment the data [symbol] _{1:t}={ [symbol] _{1:t-1}, (xₜ, yₜ)} and update the GP.

end for

For example, in one or more scenarios, expected improvement may be defined as:

EI(x)= [symbol] max(f(x)−f(x⁺), 0)

Where f(x⁺) is the value of the best sample so far and x⁺ is the location of that sample, e.g., x⁺=argmaxₓ_{ᵢ}_{∈x}_{_{1:t}}f(xᵢ). The expected improvement (EI) can be evaluated analytically under the GP model as, for example:

$$EI ( x ) = \{ \begin{matrix}( μ ( x ) - f ( {x}^{+} ) - ξ ) φ ( Z ) + σ ( x ) φ ( Z ) , if σ ( x ) > 0 ( \begin{matrix}exploitation term , \\ exploration term\end{matrix} ) \\ 0 , if σ ( x ) = 0\end{matrix} \\ where \\ Z = \{ \begin{matrix}\frac{μ ( x ) - f ( {x}^{+} ) - ξ}{σ ( x )} & if σ ( x ) > 0 \\ 0 & if σ ( x ) = 0\end{matrix}$$

For example, in one or more scenarios, μ(x) and σ(x) are the mean and the standard deviation of the GP posterior predictive at x, respectively. Also for example, Φ and ϕ are the Cumulative Distribution Function (CDF) and the Probability Density Function (PDF) of the standard normal, respectively.

For example, in one or more scenarios, for a time-step t, xₜ is the sampling point at t; [symbol] _{1:t-1} are the t−1 samples drawn from the objective function f so far; μ(x [symbol] _{1:t-1}) is the acquisition function of the sampling point given the data; f (x⁺) is the value of the best sample so far and x⁺ is its location; εₜ denotes noise (e.g., possibly sampling a noisy objective function); ξ is a parameter that determines the amount of exploration; and f(xᵢ) is the objective function in Bayesian optimization, which is the function for which the optimization determines the input values that optimize/maximize or minimize the value of f over the domain.

One or more techniques described herein may enable system users to quickly, easily, and/or accurately identify and/or maintain a library of cloud-based/non-cloud-based software (e.g., application, program, code, etc.) that may be used across an entire organization, or broad parts thereof. Such use may include analyzing and/or applying one or more machine learning models to outbound financial transactions that perhaps were previously able to be analyzed through (e.g., only through) a manual review of data.

In one or more scenarios, one or more Extract, Transform and Load (ETL) processes may be run against financial transaction data that may be flowing into the platform. This financial transaction data (e.g., that may encompass a plurality of file types, and/or non-financial data, such as inventory data, asset listing data, etc.) may come into the platform through, at 202, one or more direct API based integrations and/or through a batch file upload, at 204, for example. Perhaps for example once the financial transaction data is loaded in the platform database, the text may be cleaned and/or vectorized. The software providers may be encoded. The cleansing, encoding, and/or transformation process(es) may include one or more of: tokenizing sentences into words, transforming words and/or sentences into lowercase, dealing with missing data, removing non-alphanumerical symbols, and/or combining text across different fields in the financial transaction data. In one or more scenarios, this may ensure that the data moving through the platform analysis is in a uniform standard and/or is formatted in a manner that allows the one or more models to be trained and/or make matches holistically across different platform customers/users.

In one or more scenarios, the one or more models may be trained in one or more unique and/or specific ways, perhaps for example using the data previously received and/or transformed. The transformed text data may be converted into at least two types of vector representations: TF-IDF vectorization and/or word embedding. TF-IDF (term frequency-inverse document frequency) vectorization may be used in abstracting documents into vector representations by assigning scores to words based on the frequencies of one or more, or each, word, perhaps for example within a transaction and/or across one or more, or all, transactions in the platform dataset. One or more, or each sequence of words may be represented as a vector containing the scores of one or more, or each, word in the sequence relative to one or more, or all, the words in the corpus. The second vector representation (e.g.., the word embedding model) may represent one or more, or each, sequence of words as a dense numerical vector where one or more, or each word in the sequence may be represented by a point in the embedding space. The points may be learned and/or moved around, perhaps for example based on the words that surround it in the platform dataset (e.g., financial transaction dataset).

In one or more scenarios, Term Frequency—Inverse Document Frequency may be expressed, for example, as:

$${w}_{i , j} = {tf}_{i , j} \times log ( \frac{N}{{df}_{i}} )$$

where, tf_{i,j}=number of occurrences of word i in document j;
dfᵢ=number of documents containing word i; and
N=total number of documents

These vector representations of financial transaction data may be fed as input into one or more (e.g., a suite) of classical (e.g., logistic regression, random forest, and/or gradient boosted) models and/or a long-short term convolutional neural network model, perhaps for example in order to analyze the data and/or to train the one or more models to find matches. The one or more models may be trained with this data and/or their associated labels, and/or may be fine-tuned to maximize accuracy at the individual transaction level and/or with the ensemble/suite's ability to identify one or more software expenditures in (e.g., large) amounts of data. For example, a logistic regression may be expressed by the following:

$${h}_{θ} ( x ) = g ( {θ}^{T} x )$$

$$g ( z ) = \frac{1}{1 + {ϵ}^{- z}}$$

For example, in one or more scenarios, g(z) is the logistic function, or sigmoid function equation, which tends to least to 1 as z approaches infinity and tends to lead toward 0 as z approaches negative infinity.

For example, in one or more scenarios, h_{θ}(x) is the hypothesis of the probability that y, a predicted output, will equal 1 given input x parameterized by θ; θ^{T} is a matrix and θ^{T}×x is the sum over i from 1 to n vectors of θᵢ×xᵢ; θᵢ are the parameters, or weights, for one or more, or each, xᵢ vector in two-dimensional vector space; y can be classified as 0 or 1, where y=0 indicates a negative class (e.g., an absence of something) and y=1 indicates a positive class (e.g., a presence of something); h_{θ}(x) can also be written as [symbol] (y=1|x; θ) which can be read as the probability that y=1 given n (an integer) is the number of features/parameters.

For example, regarding cost functions, logistic regression may minimize the following:

$${min}_{w , c} \frac{1}{2} {w}^{T} w + C {\sum }_{i = 1}^{n} log ( exp ( - {y}_{i} ( {X}_{i}^{T} w + c ) ) + 1 )$$

For example, in one or more scenarios, the first term is a regularization term of the L2 penalty (e.g., Ridge regularization); w are the parameters, or weights, for one or more, or each, of n Xᵢ vectors; C is 1/λ (e.g., the regularization term); c is an intercept, a constant offset in a linear equation, or where the line intercepts the y-axis; y is the predicted output value, a function of the input vectors and weights, and y is 0 or 1 in binary classification; Tis used as the standard notation for the transpose matrix operator; the L2 penalty is a penalty term applied to guard against overfitting (and/or add regularization); and λ is common notation for a regularization term in machine learning.

In one or more scenarios, a cross-entropy loss function may be expressed by the following:

$$CE = - {\sum }_{x} p ( x ) log q ( x )$$

For example, in one or more scenarios, p(x) is the actual probability distribution and/or q(x) is the prediction for data point x.

The one or more training routines may utilize one or more gradient descent and/or backpropagation algorithms, perhaps for example in order to fit the model. Perhaps once the training process is complete, among other scenarios, the one or more models, the text corpus, and/or the encoded software providers may be stored to be used on future data, for example. For example, a gradient descent may be determined by:

$$J ( θ ) = - \frac{1}{m} [ {\sum }_{i = 1}^{m} {y}^{( i )} log {h}_{θ} ( {x}^{( i )} ) + ( 1 - {y}^{( i )} ) log ( 1 - {h}_{θ} ( {x}^{( i )} ) ) ]$$

$$Want {min}_{θ} J ( θ ) \text{:}$$

$$Repeat \{ \\ {θ}_{j} := {θ}_{j} - α {\sum }_{i = 1}^{m} ( {h}_{θ} ( {x}^{( i )} ) - {y}^{( i )} ) {x}_{j}^{( i )} \\ \} ( simultaneously update all {θ}_{j} )$$

For example, in one or more scenarios, J(θ) is a cost function; θⱼ is the j-th weight in a weight factor θ; y⁽ⁱ⁾ is the actual value of the y coordinate for input x⁽ⁱ⁾ for the i-th value in m data points; h_{θ} is the hypothesis that is equal to the logistic function with input θ^{(T)}×x, which is the sum over i from 1 to m vectors of θ⁽ⁱ⁾×x⁽ⁱ⁾; and a is a constant that represents a learning rate.

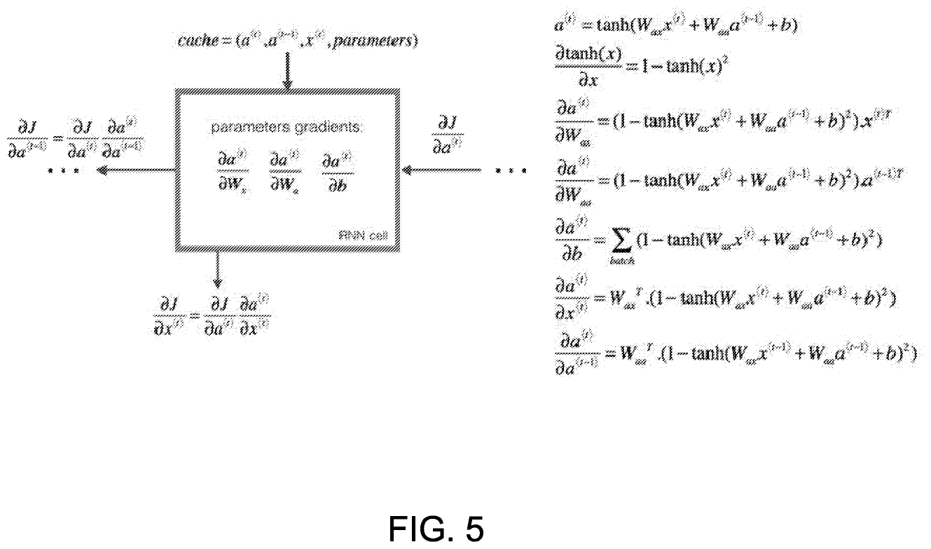

For example, FIG. 5 illustrates an example of a backpropagation, such as a recurrent neural network (RNN) cell's backward pass. In FIG. 5, the derivative of the cost function J may back-propagate through the RNN by following the chain-rule (e.g., from calculus). The chain rule may also be used to calculate:

$$\frac{\partial J}{\partial {W}_{ax}} , \frac{\partial J}{\partial {W}_{aa}} , and \text{/} or \frac{\partial J}{\partial b}$$

to update one or more of the parameters Wₐₓ (a weight matrix multiplying the input x, Wₐₐ (a weight matrix multiplying the hidden state) , and/or bₐ (a bias). For example, in one or more scenarios, t indexes one or more layers; W_{ya} is a weight matrix relating the hidden state to the output; and b is the bias relating the hidden state to the output a^{(t)}.

One or more, or all, new (e.g., recent) financial transaction data that flows into the application may undergo a (e.g. substantially similar) cleaning and/or transformation process as described herein. The transformed versions of the new financial transaction data may be fed into the previously trained models and/or the trained models may make inferences, and/or predictions, on probable matches for the new data, perhaps for example based on matches that it may have made previously.

In one or more scenarios, a number (e.g., a team) of expert consultants may review the matches made by the ensemble/suite to ensure accuracy and/or may make adjustments to the matching models, perhaps for example based on any findings during the review and/or validation. This may help to validate the performance of the one or more models and/or may ensure that the platform is providing accurate predictions. This may allow the verified data to be added to a list of ground truth samples that may be included in the training of the one or more models for future incoming data.

In one or more scenarios, one or more matches may be provided in the platform user interface and/or may be associated with one or more (e.g., specific) cloud/non-cloud software (e.g., application, program, code, etc.) subscriptions, purchases, and/or leases. Users can make further adjustments as desired, which may influence the one or more models going forward.

Perhaps for example if a user updates an application, those updates/changes may be propagated through the processes/techniques described herein. This logic may ensure that when transaction data is flowing into the platform database, the data may be cleaned, the platform/system may be applying the most recently updated models, and/or may be making the most accurate predictions possible.

In one or more scenarios, a part (e.g., an additional part) of the ensemble/suite may identify one or more transactions with components and/or data that might not have been previously seen before. By doing this, the one or more models can begin to highlight transactions for software (e.g., application, program, code, etc.) subscriptions, purchases, and/or licenses of which the matching models have yet to be trained. The current approach to doing this is to identify these items/data during the verification.

The ensemble/suite and/or the logic that may be used for training the ensemble/suite can be adjusted, perhaps for example to ensure that it is making the most accurate matches possible. In one or more scenarios, the verification process might become less significant of an element, perhaps over time, as the one or more models continue to get “smarter.”

In one or more scenarios, techniques may begin when the user may integrate an enterprise resource platform (e.g., financial system) into the analysis platform and/or may upload a batch file of outbound transactions. Perhaps for example once the data is procured, among other scenarios, the analysis platform may (e.g., automatically) cleanse and/or transform the data brought into the analysis platform and/or may, at 208, run the matching model(s) to identify one or more cloud/non-cloud software (e.g., application, program, code, etc.) subscriptions, purchases, and/or licenses. Transactions where a match is made with the one or more cloud/non-cloud software (e.g., application, program, code, etc.) subscriptions, purchases, and/or licenses may be verified and/or loaded for display on the analysis platform user interface. A user can then see one or more, or each, cloud/non-cloud software (e.g., application, program, code, etc.) subscription, purchase, and/or license, perhaps for example along with the associated financial transaction data for that subscription, purchase, and/or license. One or more techniques may continue (e.g., nightly) for integrated solutions. For scenarios involving batch file uploads, one or more techniques may occur any time a new batch file is uploaded, for example.

In one or more scenarios, the ensemble/suite of models may be trained to identify cloud-based/non-cloud-based software (e.g., application, program, code, etc.) subscription, purchase, and/or license charges found in, for example, enterprise transaction data. The ensemble/suite of models may be trained on any category of data, perhaps for example to begin to make matches and/or associate those charges with another entity inside of the analysis platform/application and/or any other platform/application that may be connected to the one or more ensemble/suite of models.

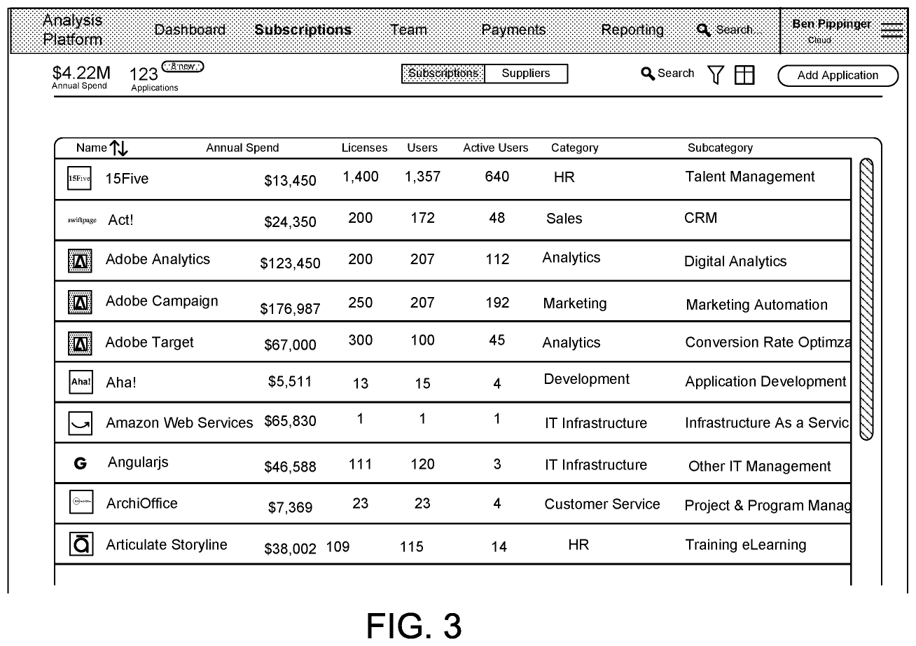

FIG. 3 illustrates an example technique analysis output according to the present disclosure. In one or more scenarios, the analysis platform/application output may paint a picture (e.g., a “dashboard”) of spending and/or adoption trends, perhaps for example broadly, across many or all users and/or customers of the enterprise resource platform systems. Perhaps for example once individual transactions are identified and/or the analysis platform standardizes and/or categorizes such spending, other insights and/or products can be created.

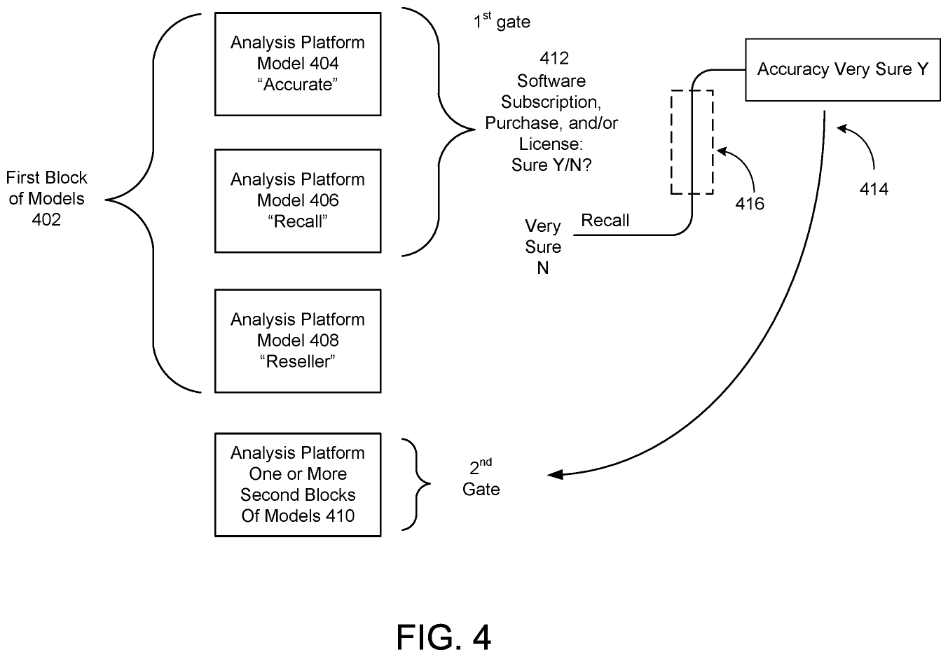

FIG. 4 is an example illustration of a technique according to the present disclosure. In FIG. 4, at 402, at least a first block of the one or more ensemble/suite of models of the analysis platform may process the data obtained from the enterprise resource/financial platform. For example, one or more models may include a model 404, a model 406, and/or a model 408. Other types of models may be used in one or more scenarios. In one or more scenarios, the model 404 and/or model 406 may act as a “first gate” of the analysis process such that at least an initial assessment may be made as to if analyzed financial data substantially corresponds to software (e.g., application, program, code, etc.) subscriptions, purchases, and/or licenses. At 412, the first gate output may produce a spectrum of analysis results that may span from a high or “very sure” degree of confidence that the results do not correspond to software (e.g., application, program, code, etc.) subscriptions, purchases, and/or licenses (e.g., a negative determination), to a high or “very sure” degree of confidence that the results do correspond to software (e.g., application, program, code, etc.) subscriptions, purchases, and/or licenses (e.g., a positive determination).

In one or more scenarios, at 414, the analyzed data that may be deemed to correspond to software (e.g., application, program, code, etc.) subscriptions, purchases, and/or licenses may be directed to a “second gate” of the analysis process. At 410, one or more of the ensemble/suite of models of at least a second block of models may further process the analyzed data, perhaps for example to determine more specific information (e.g., data, text, words, commercial language, software code/language, software titles, etc.) regarding the software (e.g., application, program, code, etc.) subscriptions, purchases, and/or licenses. In one or more scenarios, these multiple block processing techniques may allow for discovery of very specific data from large data sources, such as finding the proverbial “needle in a haystack”, for example.

One or more of the models used at 410 may include a Softmax Function. A standard (unit) softmax function: σ: [symbol] ^{K}→ [symbol] ^{K}, that may be defined by:

$${σ ( z )}_{i} = \frac{{e}^{{z}_{i}}}{{\sum }_{j = 1}^{K} {e}^{{z}_{j}}} for i = 1 , … , K and z = ( {z}_{1} , … , {z}_{K} ) ∈ {ℝ}^{K}$$

For example, in one or more scenarios, z is an input vector with K components.

In one or more scenarios, an accuracy may be determined, for example, by:

$$Accuracy = \frac{( TP + TN )}{( TP + TN + FP + FN )}$$

For example, in one or more scenarios, TP may be true positives, TN may be true negatives, FP may be false positive, and/or FN may be false negatives.

In one or more scenarios, a recall may be determined, for example, by:

$$Recall = \frac{TP}{( TP + FN )}$$

In one or more scenarios, at 416, some of the analyzed data may fall in the area between (e.g., intermediate) the span from a high or “very sure” degree of confidence that the results do not correspond to software (e.g., application, program, code, etc.) subscriptions, purchases, and/or licenses, to a high or “very sure” degree of confidence that the results do correspond to software (e.g., application, program, code, etc.) subscriptions, purchases, and/or licenses.

In other words the analyzed data may yield an indeterminate result. Such indeterminate data may be directed back to at least the first block of the one or more ensemble/suite of models and/or to at least the second block of the one or more ensemble/suite of models for further processing.

At 416, one or more sigmoid functions may be used to determine the degree of confidence. For example, a sigmoid function may be used as follows:

$$S ( x ) = \frac{1}{1 + {e}^{- x}} = \frac{{e}^{x}}{{e}^{x} + 1}$$

For example, in the sigmoid function above, x is an input.

While the disclosure has been illustrated and described in detail in the drawings and foregoing description, the same is to be considered as illustrative and not restrictive in character, it being understood that only certain examples have been shown and described and that all changes and modifications that come within the spirit of the disclosure are desired to be protected.

The foregoing detailed description has set forth various examples of the systems, devices, and/or processes via examples and/or operational diagrams. Insofar as such block diagrams, and/or examples contain one or more functions and/or operations, those within the art will understand that one or more, or each, function and/or operation within such block diagrams, and/or examples can be implemented, individually and/or collectively, in any order, by a wide range of hardware, software, and/or firmware, or any combination thereof.

Although features and/or elements are described herein in particular combinations, one of ordinary skill in the art will appreciate that one or more, or each, feature and/or element can be used alone, or in any combination with the other features and/or elements, in any order. The methods described herein may be implemented in a computer program, software, and/or firmware incorporated in a computer-readable medium for execution by a computer or processor (e.g., computing device 104).

What is claimed is:

1. A method for determining specific data from an enterprise resource platform performed by a computing device, the method comprising:
receiving one or more input data from an enterprise management platform;
preparing the input data for analysis by a machine-learning model;
performing the analysis of the prepared data using, at least, the machine-learning model;
determining at least one instance of the specific data from the prepared data based, at least, on the analysis;
storing the at least one instance of the specific data in a database;
determining at least one transaction conducted on the enterprise resource platform based on the at least one instance of the specific data; and
storing the at least one transaction in the database.

2. The method of claim 1, further comprising:
classifying the at least one transaction as a verified transaction;
training the machine-learning model using at least one of: the at least one instance of the specific data, or the verified transaction, to improve an effectiveness of the machine-learning model in the performing the analysis of the prepared data; and
storing the trained machine-learning model in the database.

3. The method of claim 2, wherein the performing the analysis of the prepared data further comprises using the trained machine-learning model on the prepared data.

4. The method of claim 1, wherein the determining the at least one instance of the specific data based, at least, on the analysis comprises:
matching the at least one instance of the specific data with one or more matching templates created during a verification of previous analysis from the machine-learning model.

5. The method of claim 1, wherein the enterprise management platform is at least one of: an enterprise resource platform system, or an expense management system.

6. The method of claim 5, wherein at least one of: the enterprise resource platform system, or the expense management system, is a cloud-based system.

7. The method of claim 1, wherein the performing analysis of the prepared data using, at least, the machine-learning model further comprises:
applying a plurality of machine-learning models to the prepared data, wherein the machine-learning model is one of the plurality of machine-learning models.

8. The method of claim 7, wherein the performing the analysis of the prepared data further comprises:
generating a first analysis result from a first block of machine-learning models of the plurality of machine-learning models;
determining an accuracy of the first result, the accuracy being at least one of: a positive determination, a negative determination, or an indeterminate determination; and
forwarding the first analysis to a second block of machine-learning models of the plurality of machine-learning models for further processing upon the accuracy of the first result being the positive determination.

9. The method of claim 8, further comprising:
identifying the prepared data corresponding to the first analysis result; and
discarding the prepared data corresponding to the first analysis result upon the accuracy of the first result being the negative determination.

10. The method of claim 8, further comprising:
forwarding the first analysis back to the first block of machine-learning models of the plurality of the machine-learning models for further processing upon the accuracy of the first result being the indeterminate determination.

11. The method of claim 1, wherein the at least one transaction is at least one of: a software subscription transaction, a software purchase transaction, or a software license transaction.

12. The method of claim 11, wherein the determining the at least one transaction conducted on the enterprise resource platform based on the at least one instance of the specific data comprises:
associating the at least one instance of the specific data with at least one of: the software subscription transaction, the software purchase transaction, or the software license transaction.

13. The method of claim 12, further comprising:
determining a measure of a reliability of the association of the at least one instance of the specific data with at least one of: the software subscription transaction, the software purchase transaction, or the software license transaction based on input from a verification process.

14. The method of claim 1, wherein the receiving the input data from the enterprise management platform comprises at least one of:
receiving the input data via an application programming interface (API) periodic processing, or receiving the input via a batch processing.

15. The method of claim 1, wherein the preparing the input data for the analysis by the machine-learning model comprises at least one of:
cleansing the input data, or transforming the input data.

16. The method of claim 15, wherein the cleansing the input data comprises at least one of:
removing one or more stopwords from the input data; or
reducing one or more ambiguous words from the input data.

17. A computing device for determining specific data from an enterprise resource platform, the device comprising:
a memory;
a display; and
a processor, the processor configured at least to:
receive one or more input data from an enterprise management platform;
prepare the input data for analysis by a machine-learning model;
perform the analysis of the prepared data using, at least, the machine-learning model;
determine at least one instance of the specific data from the prepared data based, at least, on the analysis;
store the at least one instance of the specific data in the memory;
determine at least one transaction conducted on the enterprise resource platform based on the at least one instance of the specific data;
store the at least one transaction in the memory; and
render a visually-interpretable image corresponding to the at least one transaction on the display.

18. The device of claim 17, wherein the processor is further configured to:
classify the at least one transaction as a verified transaction;
train the machine-learning model using at least one of: the at least one instance of the specific data, or the verified transaction, to improve an effectiveness of the machine-learning model in the performing the analysis of the prepared data; and
store the trained machine-learning model in the memory, wherein the processor is further configured such that the analysis of the prepared data is performed using the trained machine-learning model on the prepared data.

19. The device of claim 17, wherein the enterprise management platform is at least one of: a cloud-based enterprise resource platform system, or a cloud-based expense management system, and the at least one transaction is at least one of: a software subscription transaction, a software purchase transaction, or a software license transaction.

20. The device of claim 17, wherein the processor is further configured such that the analysis of the prepared data using, at least, the machine-learning model is performed using a plurality of machine-learning models, the machine-learning model being one of the plurality of machine-learning models, wherein the processor is further configured to:
generate a first analysis result from a first block of machine-learning models of the plurality of the machine-learning models;
determine an accuracy of the first result, the accuracy being at least one of: a positive determination, a negative determination, or an indeterminate determination;
forward the first analysis to a second block of machine-learning models of the plurality of the machine-learning models for further processing upon the accuracy of the first result being the confident determination;
forward the first analysis back to the first block of machine-learning models of the plurality of the machine-learning models for further processing upon the accuracy of the first result being the indeterminate determination;
identify the prepared data corresponding to the first analysis result; and
disregard the prepared data corresponding to the first analysis result upon the accuracy of the first result being the negative determination.
